(19) United States
(12) Patent Application Publication
(10) Pub. No.: US 2026/0075405 A1
(43) Pub. Date: Mar. 12, 2026

(54) SYSTEM AND METHOD FOR INTERNATIONAL MOBILE SUBSCRIBER IDENTITY (IMSI) SWAPPING IN SIM CARDS

(71) Applicant: JIO PLATFORMS LIMITED, Ahmedabad (IN)

(72) Inventors: Devesh Y CHAUHAN, Navi Mumbai (IN); Viraj DADIA, Mumbai (IN); Suraj R NAIR, Ghaziabad (IN); Adityakar JHA, Gurgaon (IN); Sanjay SEMWAL

(73) Assignee: JIO PLATFORMS LIMITED, Ahmedabad (IN)

(21) Appl. No.: 18/869,202

(22) PCT Filed: May 29, 2023
(86) PCT No.: PCT/IB2023/055476

§ 371 Date: Nov. 25, 2024

(30) Foreign Application Priority Data
May 30, 2022 (IN) 202221030939

(51) Int. Cl. H04W 8/20; H04W 84/04

(52) U.S. Cl. CPC H04W 8/20; H04W 84/042

(57) ABSTRACT

The present disclosure provides a system and method for international mobile subscriber identity (IMSI) swapping in subscriber identity module (SIM) cards. The system uses an applet mechanism to perform preliminary checks on the IMSI and thereafter checks if the IMSI is already swapped in which case it will disable itself and exit. In case the applet mechanism decides to swap IMSI after above checks, then the applet mechanism will not only update IMSI but also perform all other necessary actions. The applet mechanism may be used to update the fifth generation (5G) IMSI in the existing SIM cards. As the applet mechanism may update the IMSI in the SIM independent of SIM over the air (OTA)/network connectivity after being triggered, failure of services to the customer may be totally eradicated.

### RESERVATION OF RIGHTS

A portion of the disclosure of this patent document contains material, which is subject to intellectual property rights such as but are not limited to, copyright, design, trademark, integrated circuit (IC) layout design, and/or trade dress protection, belonging to Jio Platforms Limited (JPL) or its affiliates (hereinafter referred as owner). The owner has no objection to the facsimile reproduction by anyone of the patent document or the patent disclosure, as it appears in the Patent and Trademark Office patent files or records, but otherwise reserves all rights whatsoever. All rights to such intellectual property are fully reserved by the owner.

### FIELD OF INVENTION

The embodiments of the present disclosure generally relate to systems and methods for updating International Mobile Subscriber Identity (IMSI) in subscriber identity module (SIM) cards. More particularly, the present disclosure relates to a system and a method for IMSI swapping in SIM cards.

### BACKGROUND OF INVENTION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

Network connectivity issues during IR MACD, subscriber identity module (SIM) swap, and an on demand activation (ODA) activation process involves new International Mobile Subscriber Identity (IMSI) updates and other relevant elementary files (EFs) in a SIM. IMSI updates are very critical and may lead to service impacting issues to an end customer if the update is not properly completed. Further, in many cases, the target IMSI is updated successfully in subscriber's handsets whereas the same IMSI is not updated on an over the air (OTA) server due to a number of reasons like radio link failure (RLF), user equipment (UE) turning off, etc. Hence, further OTA updates may be blocked for that particular IMSI. Due to connectivity loss during the IMSI swap, the subscriber faces service impacting issues and possibly the SIM may have to be replaced. Additionally, the UE may turn off due to depletion of battery power or the user turning on an airplane mode, etc. A sudden radio link failure may happen either due to network coverage holes or more frequently due to dual-SIM devices receiving a call on another SIM card where a radio of a first SIM is turned off by the device, and thus, impacting an ongoing SIM OTA hypertext transfer protocol (HTTP)/short message service (SMS) session for the first SIM. Even though there are inbuilt retrying mechanisms available in the SIM OTA HTTP sessions or reattempts from a short message service centre (SMSC) for delivering the OTA SMS, sometimes the loss of network connectivity results in failure of completion of the scheduled OTA commands. This may potentially jeopardize the current fourth generation (4G) connectivity of the subscriber during critical EF updates like an IMSI, an Internet Protocol multimedia private identity (IMPI), and an IP multimedia public identity (IMPU), etc. Such connectivity loss during an IMSI update may result in the subscriber facing service impacting issues and possibly the SIM may have to be physically replaced.

There is, therefore, a need in the art to provide a system and a method that can mitigate the problems associated with the prior arts.

### OBJECTS OF THE INVENTION

Some of the objects of the present disclosure, which at least one embodiment herein satisfies are listed herein below.

It is an object of the present disclosure to provide a system and a method where an International Mobile subscriber Identity (IMSI) swap of a subscriber may be performed by a simple, lightweight new subscriber identity module (SIM) applet instead of an over the air (OTA) server on the fly in runtime.

It is an object of the present disclosure to provide a system and a method that decouples the IMSI switching process from being in runtime over the air to locally through the SIM applet and guarantees a successful swap irrespective of sudden network connectivity loss.

It is an object of the present disclosure to provide a system and a method where the new SIM applet is able to update IMSI and relevant elementary files (EFs) once triggered from the OTA server. The SIM applet saves the target IMSI before it is triggered (enabled) and hence in case of a failure in delivering the target IMSI to the applet, an IMSI update is not performed, and thus current services of the end user are not affected.

### SUMMARY

This section is provided to introduce certain objects and aspects of the present disclosure in a simplified form that are further described below in the detailed description. This summary is not intended to identify the key features or the scope of the claimed subject matter.

In an aspect, the present disclosure relates to a system for swapping an international mobile subscriber identity (IMSI). The system may include a processor and a memory operatively coupled to the processor that stores instructions to be executed by the processor. The processor may receive a request from a computing device. The computing device may be connected to the processor via a primary network. The request may be based on a conversion of a subscriber identity module (SIM) associated with the computing device from the primary network to a secondary network. The processor may determine that an applet mechanism is enabled. The processor may determine, via the applet mechanism, a preliminary check for the secondary network. The processor may determine if a replacement of an IMSI of the primary network is done with an IMSI of the secondary network based on the preliminary check. The processor may replace the IMSI of the primary network with the IMSI of the secondary network based on a negative determination of the replacement of the IMSI of the primary network with the secondary network.

In an embodiment, the processor may refuse the request from the computing device based on the applet mechanism being disabled.

In an embodiment, the processor may disable the applet mechanism based on a positive determination of the replacement of the IMSI of the primary network with the secondary network.

In an embodiment, the processor may update a public land mobile network (PLMN) code associated with the secondary network.

In an embodiment, the processor may use one or more elementary files (EF) to replace the IMSI of the primary network with the IMSI of the secondary network.

In an embodiment, the applet mechanism may be configured to use the one or more EF configurations and update an internet protocol multimedia private identity (IMPI) and an IP multimedia public user identity (IMPU) associated with the secondary network.

In an aspect, the present disclosure relates to a method for swapping an IMSI. The method may include receiving, by a processor associated with a system, a request from a computing device associated with a primary network. The request may be based on a conversion of a SIM associated with the computing device from the primary network to a secondary network. The method may include determining, by the processor, that an applet mechanism is enabled. The method may include determining, by the processor, via the applet mechanism, a preliminary check for the secondary network. The method may include determining, by the processor, if a replacement of an IMSI of the primary network is done with an IMSI of the secondary network based on the preliminary check. The method may include replacing, by the processor, the IMSI of the primary network with the IMSI of the secondary network based on a negative determination of the replacement of the IMSI of the primary network with the secondary network.

In an embodiment, the method may include refusing, by the processor, the request from the computing device based on the applet mechanism being disabled.

In an embodiment, the method may include disabling, by the processor, the applet mechanism based on a positive determination of the replacement of the IMSI of the primary network with the secondary network.

In an embodiment, the method may include updating, by the processor, a PLMN code associated with the secondary network.

In an embodiment, the method may include using, by the processor, one or more EF to replace the IMSI of the primary network with the IMSI of the secondary network.

In an aspect, a user equipment (UE) for sending a request may include one or more processors communicatively coupled to a processor in a system. The one or more processors may be coupled with a memory. The memory may store instructions to be executed by the one or more processors that may cause the one or more processors to transmit the request to the processor via a primary network. The request may be based on a conversion of a SIM associated with the UE, from the primary network to a secondary network. The processor may be configured to receive the request from the UE. The processor may determine that an applet mechanism is enabled. The processor may determine, via the applet mechanism, a preliminary check for the secondary network. The processor may determine if a replacement of an IMSI of the primary network is done with an IMSI of the secondary network based on the preliminary check. The processor may replace the IMSI of the primary network with the IMSI of the secondary network based on a negative determination of the replacement of the IMSI of the primary network with the secondary network.

In an aspect, a non-transitory computer readable medium may include a processor with executable instructions that may cause the processor to receive a request via a computing device. The request may be based on a conversion of a SIM, associated with the computing device, from a primary network to a secondary network. The processor may determine that an applet mechanism is enabled. The processor may determine, via the applet mechanism, a preliminary check for the secondary network. The processor may determine if a replacement of an IMSI of the primary network is done with an IMSI of the secondary network based on the preliminary check. The processor may replace the IMSI of the primary network with the IMSI of the secondary network based on a negative determination of the replacement of the IMSI of the primary network with the secondary network.

### BRIEF DESCRIPTION OF DRAWINGS

The accompanying drawings, which are incorporated herein, and constitute a part of this disclosure, illustrate exemplary embodiments of the disclosed methods and systems which like reference numerals refer to the same parts throughout the different drawings. Components in the drawings are not necessarily to scale, emphasis instead being placed upon clearly illustrating the principles of the present disclosure. Some drawings may indicate the components using block diagrams and may not represent the internal circuitry of each component. It will be appreciated by those skilled in the art that disclosure of such drawings includes the disclosure of electrical components, electronic components, or circuitry commonly used to implement such components.

FIG. 1 illustrates an exemplary network architecture (100) of a proposed system (110), in accordance with an embodiment of the present disclosure.

FIG. 2 illustrates an exemplary block diagram (200) of a proposed system (110), in accordance with an embodiment of the present disclosure.

FIG. 3 illustrates an exemplary sequence flow diagram (300) for a fourth generation (4G) to fifth generation (5G) conversion, in accordance with an embodiment of the present disclosure.

FIG. 4 illustrates an exemplary flow chart (400) for implementing an international mobile subscriber identity (IMSI) swap applet, in accordance with an embodiment of the present disclosure.

FIGS. 5A-5B illustrate exemplary flow charts (500A, 500B) for implementing a subscriber identity module (SIM) swap applet, in accordance with embodiments of the present disclosure.

FIG. 6 illustrates an exemplary computer system (600) in which or with which the embodiments of the present disclosure may be implemented.

The foregoing shall be more apparent from the following more detailed description of the disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

The ensuing description provides exemplary embodiments only and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosure as set forth.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

Also, it is noted that individual embodiments may be described as a process that is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent exemplary structures and techniques known to those of ordinary skill in the art. Furthermore, to the extent that the terms “includes,” “has,” “contains,” and other similar words are used in either the detailed description or the claims, such terms are intended to be inclusive in a manner similar to the term “comprising” as an open transition word without precluding any additional or other elements.

Reference throughout this specification to “one embodiment” or “an embodiment” or “an instance” or “one instance” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the disclosure. As used herein, the singular forms “a”, “an”, and “the” are intended to include the plural forms as well, unless the context indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

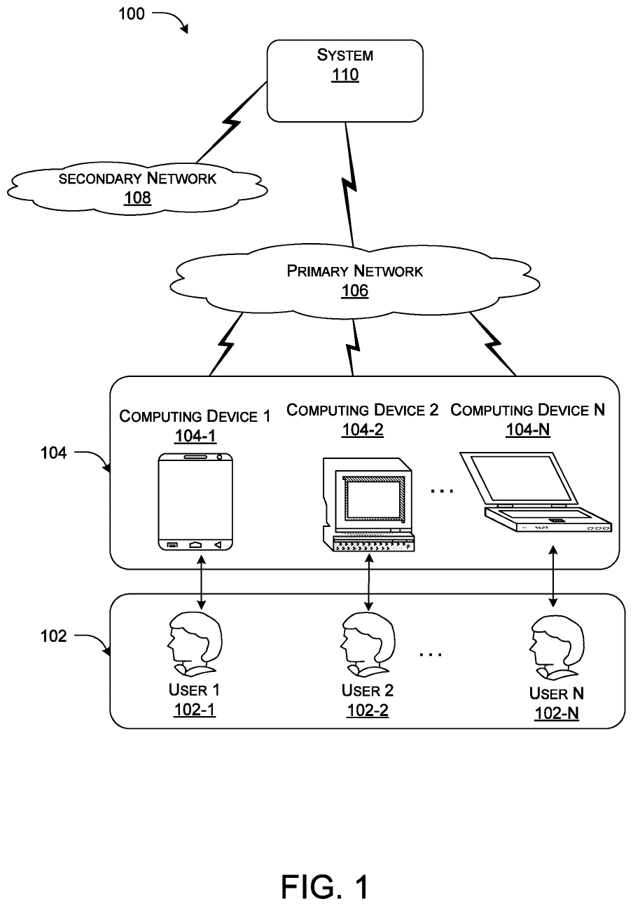

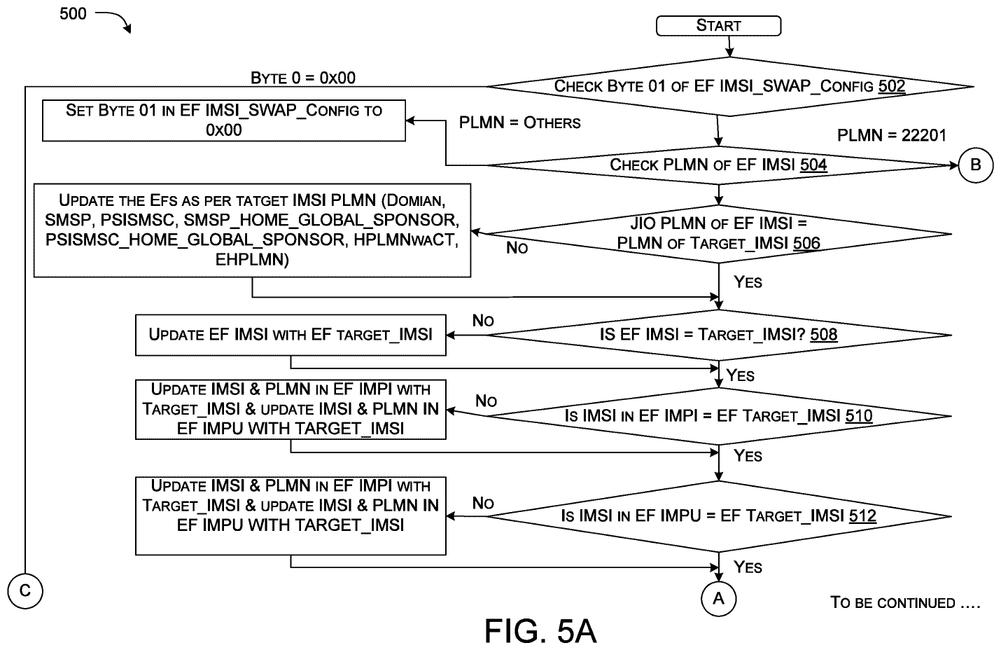

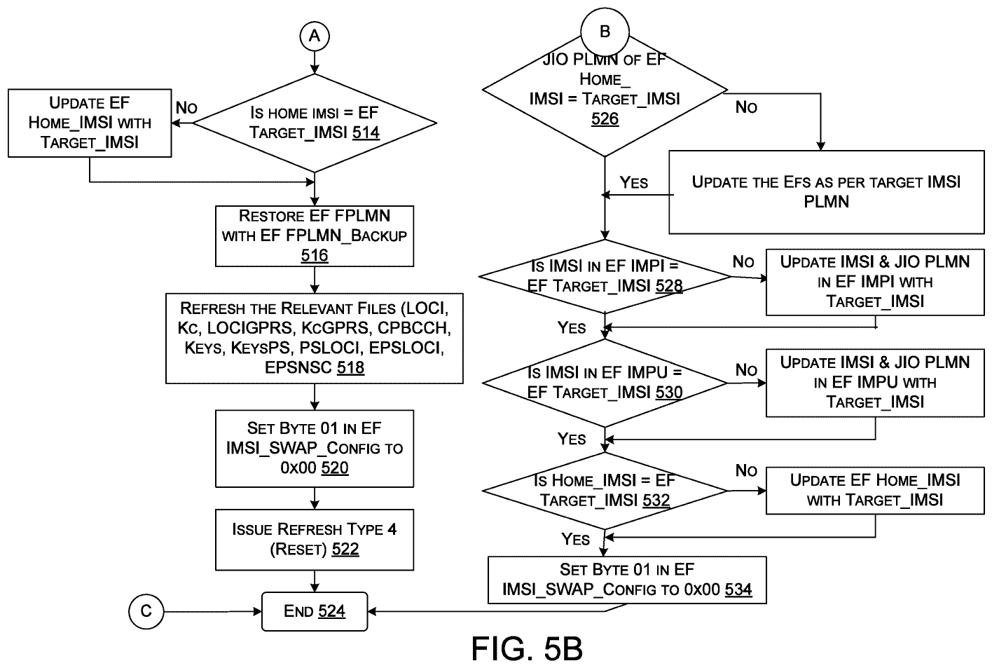

The various embodiments throughout the disclosure will be explained in more detail with reference to FIGS. 1-6.

FIG. 1 illustrates an exemplary network architecture (100) of a proposed system (110), in accordance with an embodiment of the present disclosure.

As illustrated in FIG. 1, the network architecture (100) may include a system (110). The system (110) may be connected to one or more computing devices (104-1, 104-2 . . . 104-N) via a network (106). The one or more computing devices (104-1, 104-2 . . . 104-N) may be interchangeably specified as a user equipment (UE) (104) and be operated by one or more users (102-1, 102-2 . . . 102-N). Further, the one or more users (102-1, 102-2 . . . 102-N) may be interchangeably referred as a user (102) or users (102).

In an embodiment, the computing devices (104) may include, but not be limited to, a mobile, a laptop, etc. Further, the computing devices (104) may include a smartphone, virtual reality (VR) devices, augmented reality (AR) devices, a general-purpose computer, desktop, personal digital assistant, tablet computer, and a mainframe computer. Additionally, input devices for receiving input from the user (102) such as a touch pad, touch-enabled screen, electronic pen, and the like may be used. A person of ordinary skill in the art will appreciate that the computing devices (104) may not be restricted to the mentioned devices and various other devices may be used.

In an embodiment, the network (106) may include, by way of example but not limitation, at least a portion of one or more networks having one or more nodes that transmit, receive, forward, generate, buffer, store, route, switch, process, or a combination thereof, etc. one or more messages, packets, signals, waves, voltage or current levels, some combination thereof, or so forth. The network (106) may also include, by way of example but not limitation, one or more of a wireless network, a wired network, an internet, an intranet, a public network, a private network, a packet-switched network, a circuit-switched network, an ad hoc network, an infrastructure network, a Public-Switched Telephone Network (PSTN), a cable network, a cellular network, a satellite network, a fiber optic network, or some combination thereof.

In an embodiment, the system (110) may receive a request from the computing device (104). The request may be based on a conversion of a subscriber identity module (SIM) associated with the computing device (104), from the network, i.e., a primary network (106) to a secondary network (108). It may be appreciated that the secondary network (108) may be similar to the examples of the network (106), as discussed above. The system (110) may determine if an applet mechanism has been enabled. The system (110) may, in response to a positive determination, determine, via the applet mechanism, a preliminary check for the secondary network (108). The system (110) may determine if a replacement of an international mobile subscriber entity (IMSI) of the primary network (106) is done with an IMSI of the secondary network (108) based on a positive determination of the preliminary check.

In an embodiment, the system (110) may use one or more elementary files (EF) to replace the IMSI of the primary network (106) with the IMSI of the secondary network (108). The applet mechanism may be configured to use the one or more EF and update an internet protocol multimedia private identity (IMPI) and an internet protocol multimedia public user identity (IMPU) associated with the secondary network (108).

In an embodiment, system (110) may replace the IMSI of the primary network (106) with the IMSI of the secondary network (108) based on a negative determination of the replacement of the IMSI of the primary network (106) with the secondary network (108).

In an embodiment, the system (110) may, in response to a negative determination of enablement of the applet mechanism, refuse accepting the request from the computing device (104).

In an embodiment, the system (110) may disable the applet mechanism based on a positive determination of the replacement of the IMSI of the primary network (106) with the secondary network (108).

In an embodiment, the system (110) may terminate a process of receiving the request based on a negative determination of enablement of the applet mechanism. Further, the system (110) may update a public land mobile network (PLMN) code associated with the secondary network (108).

Although FIG. 1 shows exemplary components of the network architecture (100), in other embodiments, the network architecture (100) may include fewer components, different components, differently arranged components, or additional functional components than depicted in FIG. 1. Additionally, or alternatively, one or more components of the network architecture (100) may perform functions described as being performed by one or more other components of the network architecture (100).

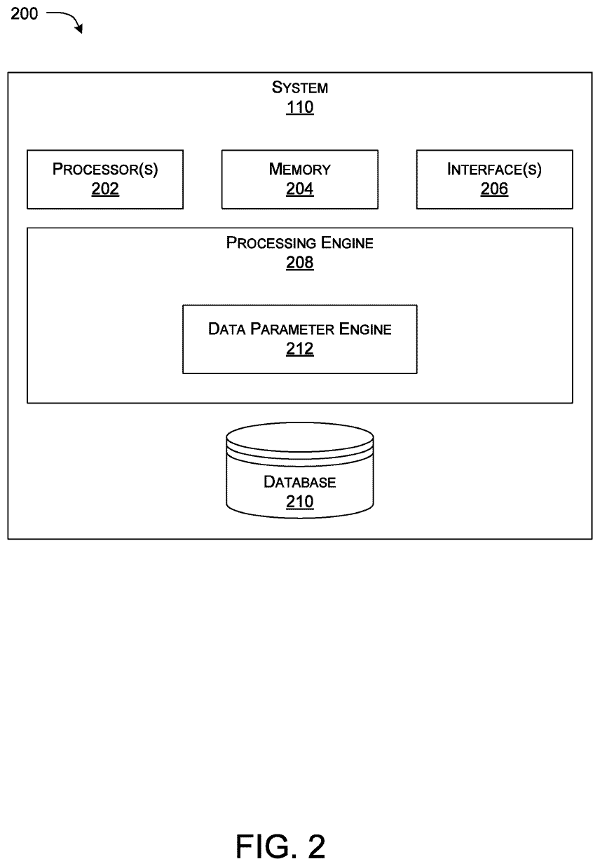

FIG. 2 illustrates an exemplary block diagram (200) of a proposed system (110), in accordance with an embodiment of the present disclosure.

Referring to FIG. 2, the system (110) may comprise one or more processor(s) (202) that may be implemented as one or more microprocessors, microcomputers, microcontrollers, digital signal processors, central processing units, logic circuitries, and/or any devices that process data based on operational instructions. Among other capabilities, the one or more processor(s) (202) may be configured to fetch and execute computer-readable instructions stored in a memory (204) of the system (110). The memory (204) may be configured to store one or more computer-readable instructions or routines in a non-transitory computer readable storage medium, which may be fetched and executed to create or share data packets over a network service. The memory (204) may comprise any non-transitory storage device including, for example, volatile memory such as random-access memory (RAM), or non-volatile memory such as erasable programmable read only memory (EPROM), flash memory, and the like.

In an embodiment, the system (110) may include an interface(s) (206). The interface(s) (206) may comprise a variety of interfaces, for example, interfaces for data input and output (I/O) devices, storage devices, and the like. The interface(s) (206) may also provide a communication pathway for one or more components of the system (110). Examples of such components include, but are not limited to, processing engine(s) (208) and a database (210), where the processing engine(s) (208) may include, but not be limited to, a data parameter engine (212).

In an embodiment, the processing engine(s) (208) may be implemented as a combination of hardware and programming (for example, programmable instructions) to implement one or more functionalities of the processing engine(s) (208). In examples described herein, such combinations of hardware and programming may be implemented in several different ways. For example, the programming for the processing engine(s) (208) may be processor-executable instructions stored on a non-transitory machine-readable storage medium and the hardware for the processing engine(s) (208) may comprise a processing resource (for example, one or more processors), to execute such instructions. In the present examples, the machine-readable storage medium may store instructions that, when executed by the processing resource, implement the processing engine(s) (208). In such examples, the system (110) may comprise the machine-readable storage medium storing the instructions and the processing resource to execute the instructions, or the machine-readable storage medium may be separate but accessible to the system (110) and the processing resource. In other examples, the processing engine(s) (208) may be implemented by electronic circuitry.

In an embodiment, the processor (202) may receive a request, via the data parameter engine (212), from a computing device (e.g., 104). The processor (202) may store the received request in the database (210). The request may be based on a conversion of a SIM associated with the computing device (104), from a primary network (106) to a secondary network (108).

In an embodiment, the processor (202) may determine if an applet mechanism has been enabled. The processor (202) may, in response to a positive determination, determine, via the applet mechanism, a preliminary check for the secondary network (108). The processor (202) may determine if a replacement of an IMSI of the primary network (106) is done with an IMSI of the secondary network (108) based on a positive determination of the preliminary check.

In an embodiment, the processor (202) may use one or more EF to replace the IMSI of the primary network (106) with the IMSI of the secondary network (108). The applet mechanism may be configured to use the one or more EF and update an IMPI and an IMPU associated with the secondary network (108).

In an embodiment, the processor (202) may replace the IMSI of the primary network (106) with the IMSI of the secondary network (108) based on a negative determination of the replacement of the IMSI of the primary network (106) with the secondary network (108).

In an embodiment, the processor (202) may, in response to a negative determination of enablement of the applet mechanism, refuse accepting the request from the computing device (104).

In an embodiment, the processor (202) may disable the applet mechanism based on a positive determination of the replacement of the IMSI of the primary network (106) with the secondary network (108).

In an embodiment, the processor (202) may terminate a process of receiving the request based on a negative determination of enablement of the applet mechanism. Further, the processor (202) may update a PLMN code associated with the secondary network (108).

Although FIG. 2 shows exemplary components of the system (110), in other embodiments, the system (110) may include fewer components, different components, differently arranged components, or additional functional components than depicted in FIG. 2. Additionally, or alternatively, one or more components of the system (110) may perform functions described as being performed by one or more other components of the system (110).

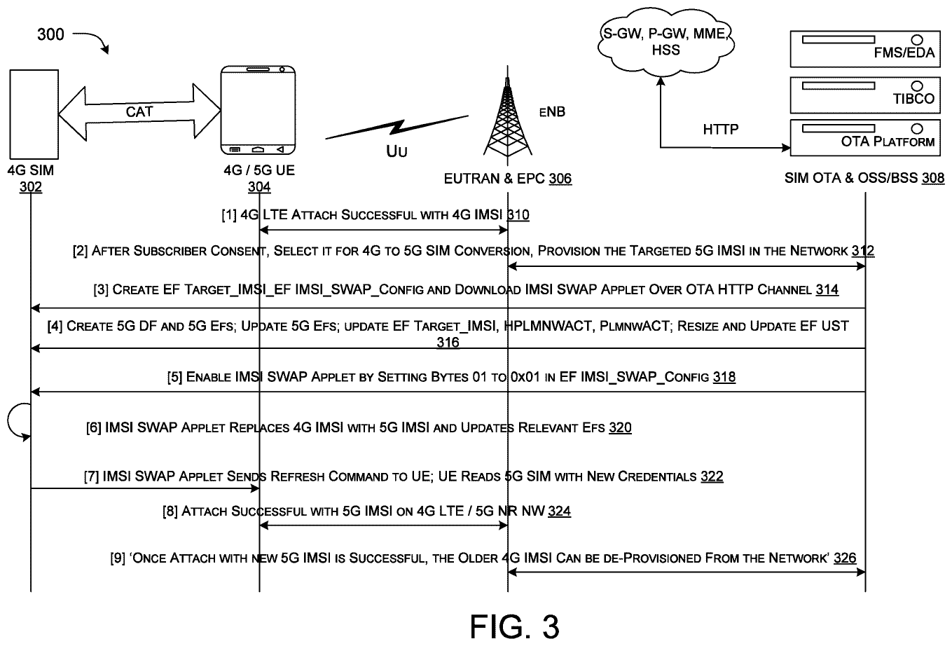

FIG. 3 illustrates an exemplary sequence flow diagram (300) for a fourth generation (4G) to fifth generation (5G) conversion, in accordance with an embodiment of the present disclosure.

At step 310: The 4G long-term evolution (LTE) SIM (302) may attach successfully with the 4G IMSI across the 4G/5G UE (304) and the Evolved Universal Terrestrial Radio Access Network (EUTRAN)/Evolved Packet Core (EPC) (306).

At step 312: Based on a subscriber consent, the 4G LTE may be selected for the 4G to 5G conversion across the EUTRAN/EPC (306) and a SIM over-the-air (OTA) and operation support system (OSS)/business support system (BSS) (310).

At step 314: The system (e.g., 110) may create an EF_Target_IMSI_EF_IMSI_SWAP_Config and download IMSI swap applet over an OTA hyper-text transfer protocol (HTTP) channel across a 4G SIM (302), the 4G/5G UE (304), the EUTRAN and EPC (306), and the SIM OTA and OSS/BSS (310).

At step 316: The system (110) may create 5G DF and 5G EFs, update 5G EFs, update target_IMSI, HPLMNWACT, PLMNwACT, resize and update EF UST across the 4G SIM (302), the 4G/5G UE (304), the EUTRAN and EPC (306), and the SIM OTA and OSS/BSS (310).

At step 318: The system (110) may enable IMSI swap applet by setting Byte 01 to 0x01 in EF IMSI_SAWP_Config across the 4G SIM (302), the 4G/5G UE (304), the EUTRAN and EPC (306), and the SIM OTA and OSS/BSS (310).

At step 320: The IMSI swap applet may replace the 4G IMSI with the 5G IMSI and update relevant EFs across the 4G SIM (302), the 4G/5G UE (304), the EUTRAN and EPC (306), and the SIM OTA and OSS/BSS (310).

At step 322: The IMSI swap applet may send a REFRESH command to the UE, where the UE may read the 5G SIM with the new credentials across the 4G SIM (302) and the 4G/5G UE (304).

At step 324: The IMSI swap applet may be successful with the 5G IMSI on the 4G LTE/5G new radio (NR).

At step 326: Once attach with the new 5G IMSI is successful, the older 4G IMSI may be de-provisioned from the network.

Therefore, in accordance with embodiments of the present disclosure, a 4G SIM may be present in a 4G/5G device and may be attached to the 4G network (NW) initially. Before performing a 4G to 5G SIM conversion operation on subscriber's SIM, the subscriber's consent may be sought. Post that, a new 5G IMSI may be allocated to the subscriber. The new 5G IMSI may be provisioned in the network. Thereafter, two transparent EFs may be created viz. EF Target_IMSI as shown in Table 1 and the EF IMSI_SWAP_Config and the IMSI swap applet may be downloaded on SIM.

TABLE 1

| EF ID | EF Name | Action |
|---|---|---|
| 99FF/3040 | Target_IMSI | New EF Creation |
| 99FF/3041 | IMSI_SWAP_Config | New EF Creation |

Next step will have IMSI specific data apart from common commands. The IMSI data part may be split into part BOM/OPM campaigns. In this step, necessary 5G DF and EF may be created and updated and other EFs may also updated as shown in Table 2. Following new 5G DF and EFs may be created and updated with appropriate values via the BOM campaign.

TABLE 2

| EF ID | EF Name | Action |
|---|---|---|
| 5FC0 | 5GS DF | New DF Creation |
| 4F01 | 5GS3GPPLOCI | New EF Creation |
| 4F02 | 5GSN3GPPLOCI | New EF Creation |
| 4F03 | 5GS3GPPNSC | New EF Creation |
| 4F04 | 5GSN3GPPNSC | New EF Creation |
| 4F05 | 5GAUTHKEYS | New EF Creation |
| 4F06 | UAC_AIC | New EF Creation |
| 4F07 | SUCI_Calc_Info | New EF Creation |
| 4F08 | OPL5G | New EF Creation |
| 4F09 | NSI | New EF Creation |
| 4F0A | Routing Indicator | New EF Creation |

Following EFs may be updated via a BOM campaign as shown in Table 3.

TABLE 3

| EF ID | EF Name | Action |
|---|---|---|
| 6F38 | UST | EF Resize and Update |
| 6F62 | HPLMNwACT | EF Update (RAT Value) |
| 6F60 | PLMNwACT | EF Update |

Following EF of IMSI swap applet is updated as below through an OPM flow as shown in Table 4.

TABLE 4

| EF ID | EF Name | Action |
|---|---|---|
| 99FF/3040 | Target_IMSI | Update with new 5G IMSI |

In an embodiment, on successful completion of the earlier mentioned steps, the IMSI swap applet may be enabled by setting Byte 01 to 0x01 in EF IMSI_SWAP_Config through a BOM campaign. Further, the IMSI SWAP Applet may replace the 4G IMSI with the 5G IMSI and update relevant EF's. Post successful IMSI change, the IMSI SWAP Applet may trigger REFRESH which may result in the UE detaching from the 4G network with the 4G IMSI. The UE (304) may read contents of the new 5G SIM with new 5G credentials including new 5G IMSI. After this, the UE (304) may make fresh attach attempts with the available 4G LTE or 5G NR network. New attach request from the UE (304) with 5G IMSI may be successful on either 4G LTE NW or 5G NR NW as the new 5G IMSI was already provisioned in the network at the beginning. On receiving a confirmation from a core network about a successful subscriber attach with new 5G IMSI, the older 4G IMSI may be de-provisioned from the core network, OSS/BSS, SIM OTA platform.

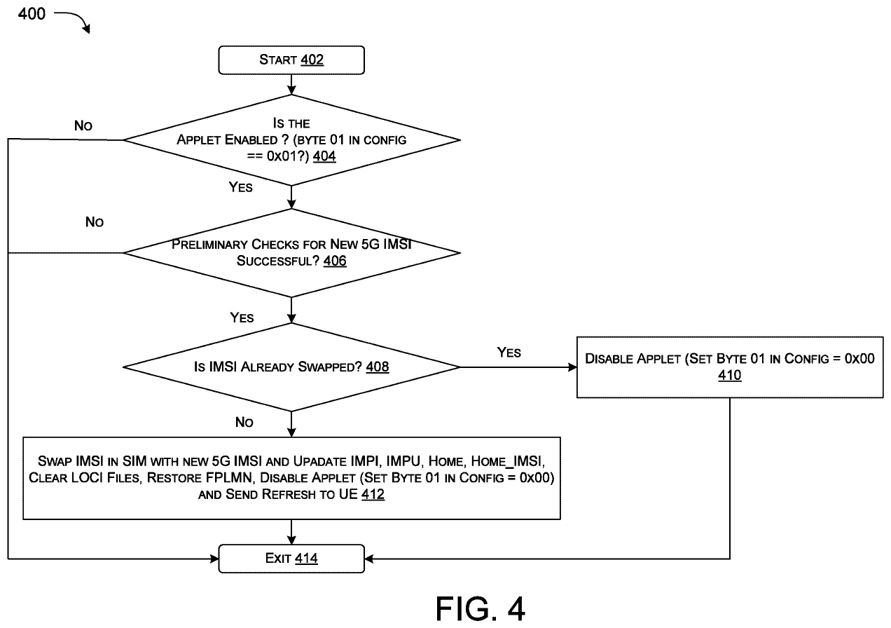

FIG. 4 illustrates an exemplary flow chart (400) for implementing an IMSI swap applet, in accordance with an embodiment of the present disclosure.

As illustrated in FIG. 4, the following steps may be followed by the system (110).

At step 402: The system (110) may be enabled.

At step 404: The system (110) may determine if the applet is enabled. Based on a negative determination from this step, the system (110) may terminate/exit the process.

At step 406: Based on a positive determination from step 404, the system (110) may further determine if preliminary checks for the new 5G IMSI is successful. Based on a negative determination from this step, the system (110) may terminate/exit the process.

At step 408: Based on a positive determination from step 406, the system (110) may determine if the IMSI has been already swapped.

At step 410: Based on a positive determination from step 408, the system (110) may disable the applet.

At step 412: Based on a negative determination from step 408, the system (110) may swap IMSI in SIM with the new 5G IMSI and update the IMPI, IMPU, Home_IMSI, clear LOCI files, restore FPLMN, disable the applet, and send REFRESH to the UE.

At step 414: Further, the system (110) may terminate/exit the process.

TABLE 5
Coding as per EF-IMSI

| | | |
|---|---|---|
| Identifier: ‘3040’ | Structure: transparent | Optional |

| File size: 9 bytes | | Update activity: low |
|---|---|---|
| Access Conditions: | | |
| READ | PIN | |
| UPDATE | ADM | |
| DEACTIVATE | ADM | |
| ACTIVATE | ADM | |

| Bytes | Description | M/O | Length |
|---|---|---|---|
| 1 to 9 bytes | Target IMSI | M | 9 byte |

TABLE 6

| | | |
|---|---|---|
| Identifier: ‘3041’ | Structure: transparent | Optional |

| File size: 6 bytes | | Update activity: low |
|---|---|---|
| Access Conditions: | | |
| READ | PIN | |
| UPDATE | ADM | |
| DEACTIVATE | ADM | |
| ACTIVATE | ADM | |

| Bytes | Description | M/O | Length |
|---|---|---|---|
| 1 | Applet Enable/Disable | M | 1 byte |
| 2 to 6 bytes | RFU | M | 5 bytes |

Table 5 above shows coding as per EF-IMSI, while Table 6 above shows EF IMSI_SWAP_Config Description where the applet may be enabled and disabled. Further, settings for the applet may be enabled/disabled based on requirements.

FIGS. SA-5B illustrate exemplary flow chart (500A, 500B) for implementing a SIM swap applet, in accordance with embodiments of the present disclosure.

At step 502: The system (110) may check Byte 01 of EF IMSI_SWAP_config, if 0x01, proceed further, or else EXIT.

At step 504: Based on a positive determination from step 502, the system (110) may check PLMN of EF IMSI. Based on a negative determination from this step, the system (110) may set Byte 01 in EF IMSI_Swap_Config to 0x00 when PLMN is equal to others. Further the system (110) may proceed to exit.

At step 506: Based on a positive determination from step 504, the system (110) may determine if PLMN of EF IMSI is equal to PLMN of target IMSI. Based on a negative determination from this step, the system (110) may update EFs as per the target IMSI PLMN and further go to step 508.

At step 508: Based on a positive determination from step 506, the system (110) may determine if EF_IMSI is equal to a target IMSI. Based on a negative determination from this step, the system (110) may update EF IMSI with EF target IMSI and further go to step 510.

At step 510: Based on a positive determination from step 508, the system (110) may determine if IMSI in EF IMPI is equal to EF target IMSI. Based on a negative determination from this step, the system (110) may UPDATE IMSI and PLMN IN EF IMPI WITH TARGET_IMSI′ and UPDATE IMSI and PLMN IN EF IMPU WITH TARGET_IMSI and go to step 512.

At step 512: Based on a positive determination from step 510, the system (110) may determine if IMSI in EF IMPU is equal to EF target IMSI. Based on a negative determination from this step, the system (110) may UPDATE IMSI and PLMN IN EF IMPI WITH TARGET_IMSI′ and UPDATE IMSI & PLMN IN EF IMPU WITH TARGET_IMSI and go to step 514.

At step 514: Based on a positive determination from step 512, the system (110) may determine if home IMSI is equal to EF target IMSI. Based on a negative determination from this step, the system (110) may update EF home IMSI with target IMSI and go to step 516.

At step 516: The system (110) may restore EF PLMN with EF PLMN backup.

At step 518: The system (110) may refresh the relevant files.

At step 520: The system (110) may set Byte 01 in EF and IMSI_SWAP_Config to 0x00.

At step 522: The system (110) may issue REFRESH type 4.

At step 524: The system (110) may exit.

At step 526: Based on a negative determination from step 504, the system (110) may further determine if PLMN of home IMSI is equal to target IMSI. Based on a negative determination from this step, the system (110) may update the target EFs as per target IMSI PLMN.

At step 528: Based on a positive determination from step 526, the system (110) may determine if IMSI in EF IMPI is equal to EF target IMSI. Based on a negative determination from this step, the system (110) may update IMSI and PLMN in EF IMPI with target IMSI.

At step 530: Based on a positive determination from step 528, the system (110) may determine if home IMSI is equal to EF target IMSI. Based on a negative determination from this step, the system (110) may update IMSI and PLMN in EF IMPU with target IMSI.

At step 532: Based on a positive determination from step 530, the system (110) may determine if home IMSI is equal to EF target IMSI. Based on a negative determination from this step, the system (110) may update EF home IMSI with target IMSI.

At step 534: Based on a positive determination from step 532, the system (110) may set Byte 01 in EF and IMSI_SWAP_Config to 0x00 and exit.

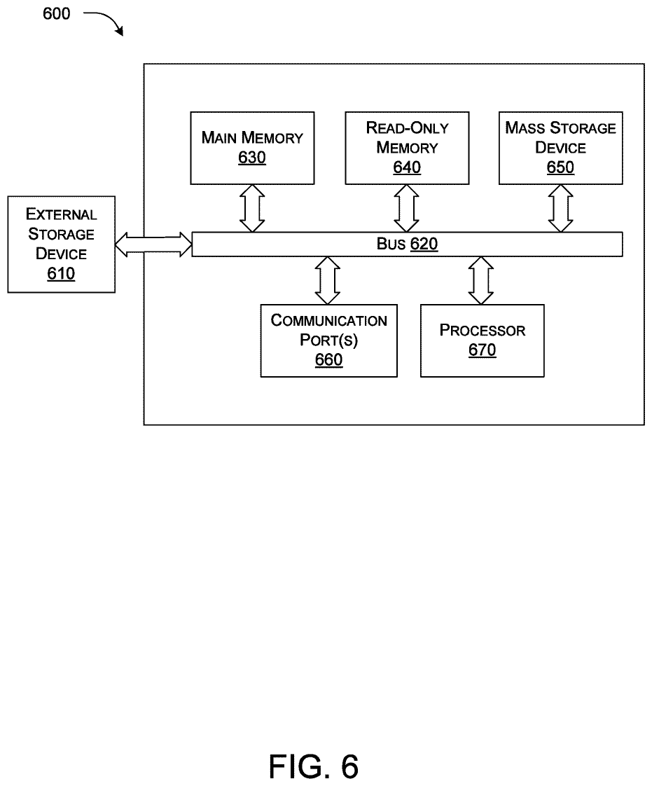

FIG. 6 illustrates an exemplary computer system (600) in which or with which the embodiments of the present disclosure may be implemented.

As shown in FIG. 6, the computer system (600) may include an external storage device (610), a bus (620), a main memory (630), a read-only memory (640), a mass storage device (650), a communication port(s) (660), and a processor (670). A person skilled in the art will appreciate that the computer system (600) may include more than one processor and communication ports. The processor (670) may include various modules associated with embodiments of the present disclosure. The communication port(s) (660) may be any of an RS-232 port for use with a modem-based dialup connection, a 10/100 Ethernet port, a Gigabit or Gigabit port using copper or fiber, a serial port, a parallel port, or other existing or future ports. The communication ports(s) (660) may be chosen depending on a network, such as a Local Area Network (LAN), Wide Area Network (WAN), or any network to which the computer system (600) connects.

In an embodiment, the main memory (630) may be Random Access Memory (RAM), or any other dynamic storage device commonly known in the art. The read-only memory (640) may be any static storage device(s) e.g., but not limited to, a Programmable Read Only Memory (PROM) chip for storing static information e.g., start-up or basic input/output system (BIOS) instructions for the processor (670). The mass storage device (650) may be any current or future mass storage solution, which can be used to store information and/or instructions. Exemplary mass storage solutions include, but are not limited to, Parallel Advanced Technology Attachment (PATA) or Serial Advanced Technology Attachment (SATA) hard disk drives or solid-state drives (internal or external, e.g., having Universal Serial Bus (USB) and/or Firewire interfaces).

In an embodiment, the bus (620) may communicatively couple the processor(s) (670) with the other memory, storage, and communication blocks. The bus (620) may be, e.g. a Peripheral Component Interconnect PCI)/PCI Extended (PCI-X) bus, Small Computer System Interface (SCSI), universal serial bus (USB), or the like, for connecting expansion cards, drives, and other subsystems as well as other buses, such a front side bus (FSB), which connects the processor (670) to the computer system (600).

In another embodiment, operator and administrative interfaces, e.g., a display, keyboard, and cursor control device may also be coupled to the bus (620) to support direct operator interaction with the computer system (600). Other operator and administrative interfaces can be provided through network connections connected through the communication port(s) (660). Components described above are meant only to exemplify various possibilities. In no way should the aforementioned exemplary computer system (600) limit the scope of the present disclosure.

While considerable emphasis has been placed herein on the preferred embodiments, it will be appreciated that many embodiments can be made and that many changes can be made in the preferred embodiments without departing from the principles of the disclosure. These and other changes in the preferred embodiments of the disclosure will be apparent to those skilled in the art from the disclosure herein, whereby it is to be distinctly understood that the foregoing descriptive matter is to be implemented merely as illustrative of the disclosure and not as a limitation.

### Advantages of the Invention

The present disclosure provides a system and a method where an International Mobile Subscriber Identity (IMSI) swap of a subscriber may be performed by a simple, lightweight new subscriber identity module (SIM) applet instead of an over the air (OTA) server on the fly in runtime.

The present disclosure provides a system and a method that decouples the IMSI switching process from being in runtime over the air to locally through the SIM applet and guarantees a successful swap irrespective of sudden network connectivity loss.

The present disclosure provides a system and a method where the new SIM applet is able to update IMSI and relevant elementary files (EFs) once triggered from the OTA server. The SIM applet saves the target IMSI before it is triggered (enabled) and hence in case of a failure in delivering the target IMSI to the applet, an IMSI update is not performed, and thus current services of the end user are not affected.

The present disclosure provides a system and a method where a requirement of pairing the IMSI with a TIM (Global) IMSI is not necessary. Hence, for sponsored roaming too, the home IMSI of subscriber may be changed.

The present disclosure provides a system and a method where during an on demand activation (ODA) activation, the temporary IMSI of the SIM is updated with the permanent IMSI. This helps in manufacturing circle agnostic SIM cards.

I/We claim:

1. A system (110) for swapping an international mobile subscriber identity (IMSI), the system (110) comprising:
a processor (202); and
a memory (204) operatively coupled with the processor (202), wherein said memory (204) stores instructions, which when executed by the processor (202), cause the processor (202) to:
receive a request from a computing device (104), wherein the computing device (104) is connected to the processor (202) via a primary network (106), and wherein the request is based on a conversion of a subscriber identity module (SIM) associated with the computing device (104) from the primary network (106) to a secondary network (108);
determine that an applet mechanism is enabled;
determine, via the applet mechanism, a preliminary check for the secondary network (108);
determine if a replacement of an IMSI of the primary network (106) is done with an IMSI of the secondary network (108) based on the preliminary check; and
replace the IMSI of the primary network (106) with the IMSI of the secondary network (108) based on a negative determination of the replacement of the IMSI of the primary network (106) with the secondary network (108).

2. The system (110) as claimed in claim 1, wherein the processor (202) is to refuse the request from the computing device (104) based on the applet mechanism being disabled.

3. The system (110) as claimed in claim 1, wherein the processor (202) is to disable the applet mechanism based on a positive determination of the replacement of the IMSI of the primary network (106) with the secondary network (108).

4. The system (110) as claimed in claim 1, wherein the processor (202) is to update a public land mobile network (PLMN) code associated with the secondary network (108).

5. The system (110) as claimed in claim 1, wherein the processor (202) is to use one or more elementary files (EFs) to replace the IMSI of the primary network (106) with the IMSI of the secondary network (108).

6. The system (110) as claimed in claim 5, wherein the applet mechanism is configured to use the one or more EF and update an internet protocol multimedia private identity (IMPI) and an IP multimedia public user identity (IMPU) associated with the secondary network (108).

7. A method for swapping an international mobile subscriber identity (IMSI), the method comprising:
receiving, by a processor (202) associated with a system (110), a request from a computing device (104) associated with a primary network (106), wherein the request is based on a conversion of a subscriber identity module (SIM), associated with the computing device (104), from the primary network (106) to a secondary network (108);
determining, by the processor (202), that an applet mechanism is enabled;
determining, by the processor (202), via the applet mechanism, a preliminary check for the secondary network (108);
determining, by the processor (202), if a replacement of an IMSI of the primary network (106) is done with an IMSI of the secondary network (108) based on the preliminary check; and
replacing, by the processor (202), the IMSI of the primary network (106) with the IMSI of the secondary network (108) based on a negative determination of the replacement of the IMSI of the primary network (106) with the secondary network (108).

8. The method as claimed in claim 7, comprising refusing, by the processor (202), the request from the computing device (104) based on the applet mechanism being disabled.

9. The method as claimed in claim 7, comprising disabling, by the processor (202), the applet mechanism based on a positive determination of the replacement of the IMSI of the primary network (106) with the secondary network (108).

10. The method as claimed in claim 7, comprising updating, by the processor (202), a public land mobile network (PLMN) code associated with the secondary network (108).

11. The method as claimed in claim 7, comprising using, by the processor (202), one or more elementary files (EFs) to replace the IMSI of the primary network (106) with the IMSI of the secondary network (108).

12. A user equipment (UE) (104) for sending a request, the UE (104) comprising:
one or more processors communicatively coupled to a processor (202) associated with a system (108), wherein the one or more processors are coupled with a memory, and wherein said memory stores instructions which, when executed by the one or more processors, cause the one or more processors to:
transmit the request to the processor (202) via a primary network (106), wherein the request is based on a conversion of a subscriber identity module (SIM), associated with the UE (104), from the primary network (106) to a secondary network (108),
wherein the processor (202) is configured to:
receive the request from the UE (104);
determine that an applet mechanism is enabled;
determine, via the applet mechanism, a preliminary check for the secondary network (108);
determine if a replacement of an international mobile subscriber entity (IMSI) of the primary network (106) is done with an IMSI of the secondary network (108) based on the preliminary check; and
replace the IMSI of the primary network (106) with the IMSI of the secondary network (108) based on a negative determination of the replacement of the IMSI of the primary network (106) with the secondary network (108).

13. A non-transitory computer readable medium comprising a processor with executable instructions, causing the processor to:
receive a request via a computing device (104), wherein the request is based on a conversion of a subscriber identity module (SIM), associated with the computing device (104), from a primary network (106) to a secondary network (108);
determine that an applet mechanism is enabled;
determine, via the applet mechanism, a preliminary check for the secondary network (108);
determine if a replacement of an international mobile subscriber entity (IMSI) of the primary network (106) is done with an IMSI of the secondary network (108) based on the preliminary check; and
replace the IMSI of the primary network (106) with the IMSI of the secondary network (108) based on a negative determination of the replacement of the IMSI of the primary network (106) with the secondary network (108).
